(19) United States
(12) Patent Application Publication
(10) Pub. No.: US 2026/0014924 A1
(43) Pub. Date: Jan. 15, 2026

(54) All-in-One Convertible Vehicle for Outdoor Cooking and Entertainment

(71) Applicant: Stephen New, SAINT ALBANS, NY (US)

(72) Inventor: Stephen New, SAINT ALBANS, NY (US)

(21) Appl. No.: 19/328,775

(22) Filed: Sep. 15, 2025

Related U.S. Application Data
(60) Provisional application No. 63/671,427, filed on Jul. 15, 2024.

(51) Int. Cl. B60P 3/34; A23B 4/052; A47J 37/07; A47J 44/00; B60N 3/16; B60P 3/42; B60R 15/02

(52) U.S. Cl. CPC B60P 3/341; A23B 4/052; A47J 37/0704; A47J 44/00; B60N 3/16; B60P 3/42; B60R 15/02

(57) ABSTRACT

A vehicle-integrated assembly for outdoor cooking and entertainment is provided. The assembly includes a body mounted on a chassis, having a front compartment, a rear compartment, and a main compartment between them. A kitchen station within the main compartment features a storage cabinet, a countertop workspace, and a sink connected to an onboard water tank. A grill and optional smoker are mounted within the front compartment and are operably coupled to its hinged cover via a lifting mechanism, which raises them into a use position when the cover is opened. Retractable front and rear awning units deploy to provide sheltered areas. The assembly integrates features such as a minibar, audio speakers, and storage solutions, and is configurable as either a self-propelled vehicle or a towable unit. This invention enables rapid deployment for comprehensive outdoor cooking and social activities while ensuring compact and organized stowage during travel.

### CROSS REFERENCE TO RELATED APPLICATIONS

This application claims priority from a U.S. Provisional Patent Application No. 63/671,427, filed on Jul. 15, 2024, which is incorporated herein by reference in its entirety.

### FIELD OF INVENTION

The present invention relates generally to mobile outdoor cooking systems and, more particularly, to a vehicle-integrated assembly that combines grilling, cooking, entertainment, and storage features into a single convertible automobile platform.

### BACKGROUND

There has been a steady increase in the number of people travelling. There has been a rising trend in the number of people making trips. Also, the travelers are preferring private vehicles instead of public transport for short as well as long trips. Travelers prefer to carry their daily necessities with them to make their trip more comfortable and economical. Spacious SUVs, caravans and minivans are becoming more popular among the travelers as they allow carry more luggage, tools, travel gear, and appliances.

More and more travelers are now preferring outdoor cooking on their trips, and they carry different items needed for cooking and washing dishes. The industry has recognized this rising trend of outdoor cooking on trips, and is inventing huge amounts in making cooking appliances more compact and portable. However, a user typically has to carry a large number of appliances, utensils, tools, and the like in an unorganized manner. A user typically relies on his memory for loading and tracking such large number of items needed for outdoor cooking. A user has to typically carry a mini kitchen in their vehicle.

The process is very laborious and time-consuming. Also, forgetting an essential item may fail the whole exercise. Also, the whole process is unorganized and manual. Considering the rising trend in outdoor cooking, a need exists for a system that can be used in vehicles and can transform into a mini kitchen.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a vehicle implemented assembly for cooking and infotainment.

Another object of the present invention is that the assembly is easy and quick to set up and use.

Another object of the present invention is that the assembly keeps different equipment organized and easy to reach.

Another object of the present invention is that the assembly provides for hassle free outdoor cooking and entertainment.

In one aspect, disclosed is a vehicle-integrated outdoor cooking and entertainment assembly. The assembly includes cooking modules, mini bar, sink, storage, speakers, and retractable awnings. The vehicle can be used in camping, tailgating, and road trips, wherein the assembly is quickly deployed and retracted, offering convenience and versatility for outdoor enthusiasts.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a side view of the vehicle showing the integrated water tank.

FIG. 2 is a side perspective view of the vehicle in its deployed configuration showing the front and rear awnings, kitchen station being pulled out, and side doors opened.

FIG. 3 shows the side view of the vehicle as shown in FIG. 2.

FIG. 4 is a top-view of the vehicle in the deployed state as in FIG. 2.

FIG. 5 is an enlarged side view showing different components of the assembly.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The present invention relates to a vehicle-implemented assembly for food preparation and entertainment. The disclosed assembly enables outdoor cooking and leisure activities by integrating an onboard mini-kitchen, mini-bar, and entertainment means. The assembly is configured for rapid deployment in an outdoor setting and for compact stowage during travel. Also disclosed is a vehicle incorporating the integral food preparation and entertainment assembly.

The disclosed assembly comprises multiple heating means to support a variety of food preparation methods. The heating means may include, without limitation, a propane stove, grill, roaster, charcoal grill, and smoker. These components are arranged to collectively form a compact mini-kitchen that may be deployed and retracted with minimal effort. The configuration ensures that all food preparation equipment and supplies are conveniently within reach of the user. The assembly further includes a mini-bar configured to accommodate essential items for preparing alcoholic beverages. The items are arranged in an organized, compact, and portable housing to facilitate accessibility and efficient use

The disclosed assembly may be configured in a compact form suitable for installation within a small vehicle, such as a sedan-sized automobile. When deployed, the vehicle-integrated assembly transforms into a versatile outdoor kitchen and entertainment system. The assembly provides multiple options for outdoor food preparation, including grilling and related cooking methods, and further supports entertainment features such as music playback. In certain embodiments, the entertainment system may include one or more speakers, audio consoles, amplifiers, or equivalent audio components. The arrangement enables creation of a small party or gathering space adjacent to the vehicle, allowing users to enjoy outdoor activities at virtually any location.

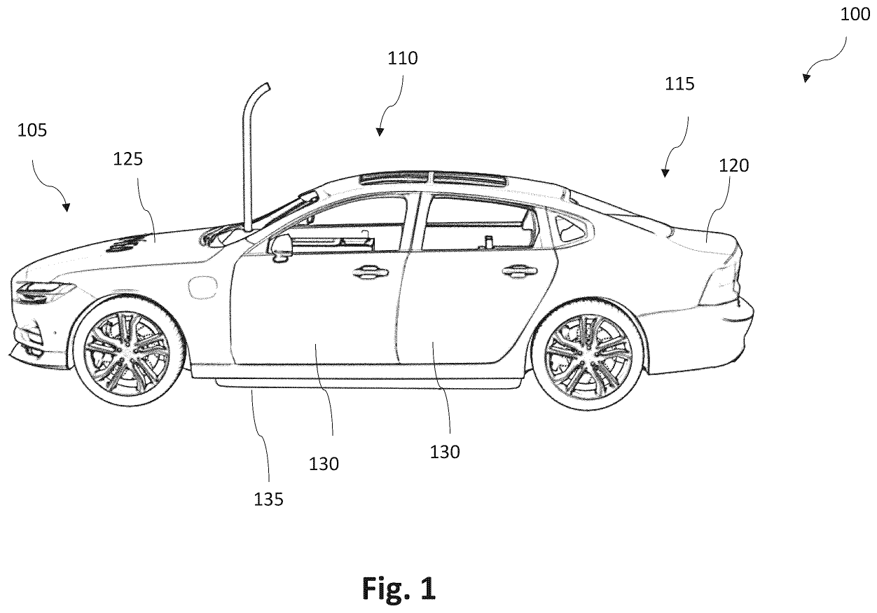

Referring to FIG. 1, which shows a side view of the disclosed vehicle 100, which is a three-compartment vehicle, similar to a sedan car. The three compartments include front compartment 105, a main compartment 110, and rear compartment 115. The front compartment has a front hinged cover 125 and the rear compartment has a rear hinged cover 120, both open upwards. The main compartment 110 has hinged side doors 130 and open sidewards.

Similar to a conventional automobile, the disclosed vehicle includes a chassis upon which a three-compartment body is mounted. The chassis is equipped with suitable wheels, a braking system, and a steering system. The vehicle may further comprise a lighting system and a power generation system. The power generation system may include, without limitation, batteries, a generator, a fuel combustion engine, solar panels, or combinations thereof. The vehicle may be self-propelled or configured for towing. In certain embodiments, the vehicle is towable via a hitch, such as a 2-inch tow bar, enabling attachment to another vehicle including, but not limited to, a sport utility vehicle (SUV), automobile, or equivalent. A steering wheel 220 may be provided within the vehicle for directional control, and one or more adjacent seats may be included for an operator or passenger. In some embodiments, the seat is reclinable, allowing the occupant to lie down. For example, when the disclosed vehicle is being towed, an occupant may rest on the reclined seat.

As illustrated in FIG. 1, a large-capacity water tank 135 may be mounted below the chassis of the vehicle. The water tank is configured to store water for various uses, including cooking, drinking, and cleaning, during both short and extended trips. In certain embodiments, the tank extends across a substantial portion of the chassis length and width while maintaining a relatively low height. This configuration advantageously minimizes water sloshing or wobbling during vehicle movement or braking, thereby enhancing stability. Additionally, one or more internal baffles may be incorporated within the tank to further reduce water movement and improve overall vehicle stability.

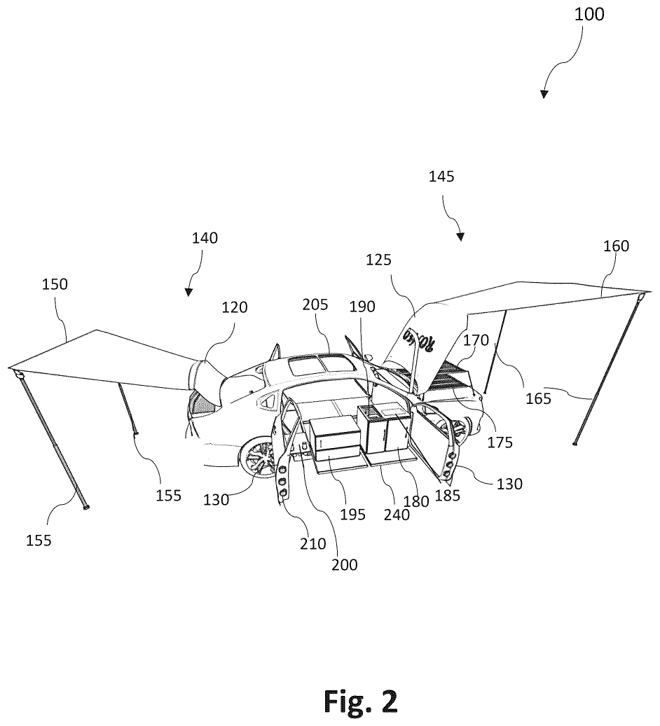

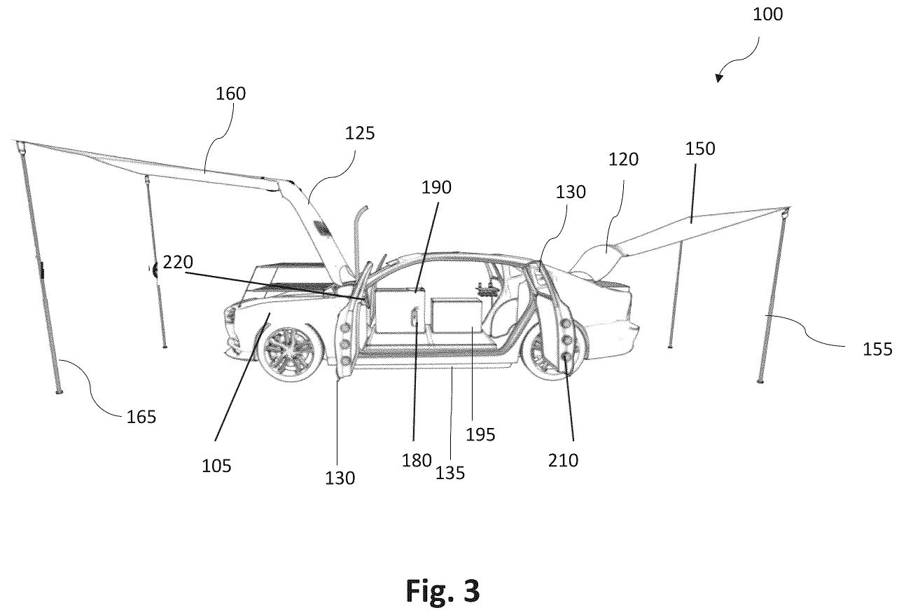

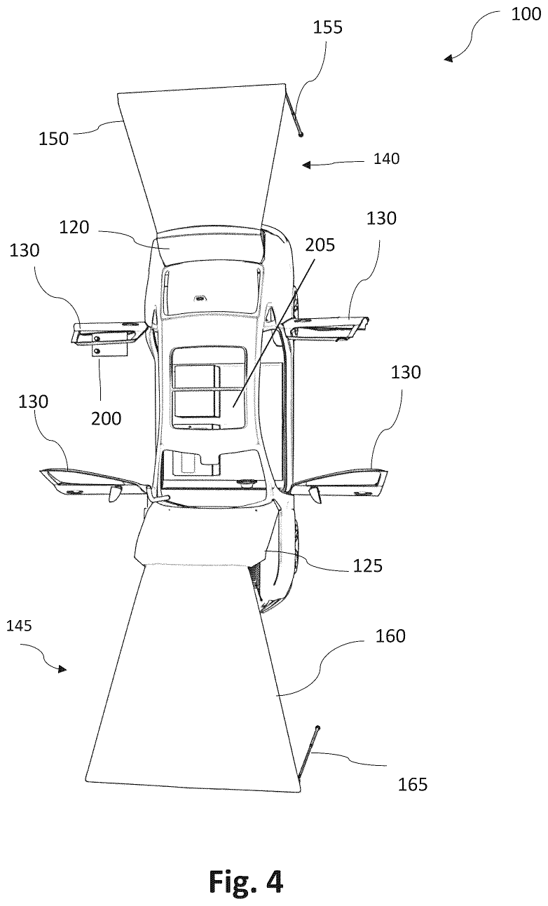

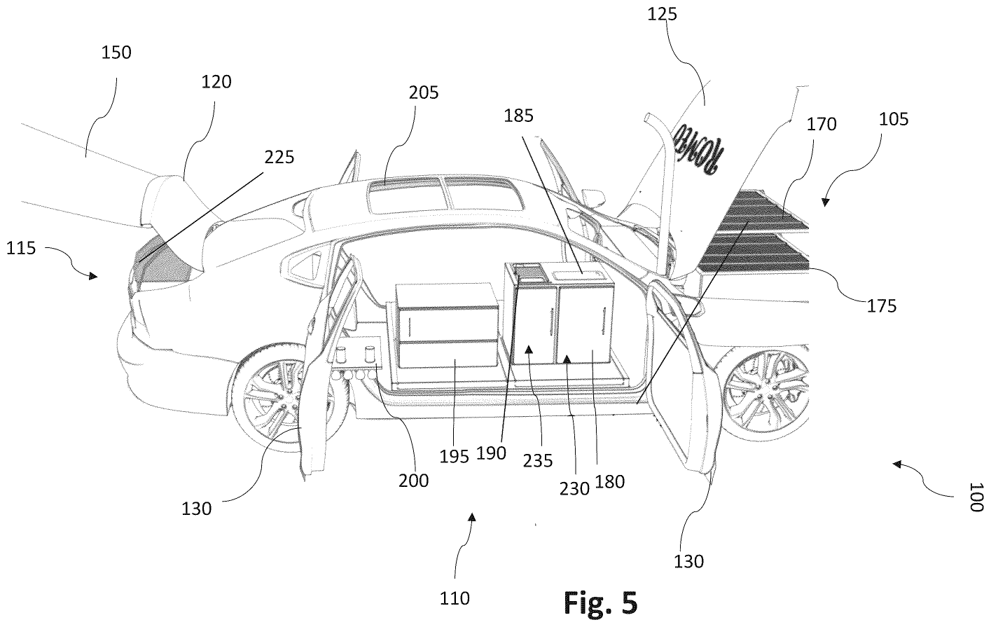

Referring to FIG. 2, which is a side perspective view showing the assembly in a deployed state, FIG. 3 shows a side view, FIG. 4 shows a top view, and FIG. 5 shows a close-up view of the disclosed vehicle 100. The assembly includes a rear awning unit 140 and a front awning unit 145. The rear awning unit can be mounted to a rear of the vehicle and the front awning unit 150 can be mounted to a front of the vehicle. The rear awning unit 140 can be stowed in the rear compartment of the vehicle and the front awning unit can be stowed in the front compartment of the vehicle.

The rear awning unit comprises an awning 150, two corners of which may be coupled to corresponding corners of the hinged cover 120 of the rear compartment. The remaining corners of the awning may be coupled to one or more support poles 155. In the embodiment shown in FIG. 2, the awning 150 is deployed by unfolding it and supporting it between the hinged cover 120 and two poles 155. The height of the poles may be adjustable, for example, by incorporating a telescoping mechanism. The lower ends of the poles may further include immobilizing means, such as rubber stoppers or ground spikes, which may be removable and replaceable to suit different terrains.

For storage, the awning and poles may be housed within the rear compartment. The telescoping feature enables compact stowage and convenient deployment. While two poles are illustrated, the number of poles may vary. For instance, an awning having five corners may be supported by three poles, and additional variations are within the scope of the invention.

When deployed, the awning provides shade in an area adjacent to the vehicle, creating a sheltered space for resting, eating, or social gatherings. In certain embodiments, a music system may be integrated into the rear compartment, including consoles and amplifiers, and powered by the vehicle's onboard power system. Optionally, party lights may be mounted on the hinged cover of the rear compartment, wherein the lights are automatically deployed upon lifting the cover.

The front awning unit 145 comprises an awning 160 supported by one or more poles 165. In certain embodiments, the front awning unit may be structurally and functionally similar to the rear awning unit, and therefore detailed description is not repeated herein. The front awning 160 provides shade adjacent to the front side of the vehicle, for example, during cooking activities. Additionally, the awnings may offer a degree of weather protection, including shielding from sun and rain. The awning may be removably coupled to the hinged cover and thus can be removed from hinged cover for storage or when not needed. Optional mosquito netting or privacy curtains can be hung from built-in loops.

The assembly further comprises a grill 170 and a smoker 175 installed within the front compartment of the vehicle. The grill 170 and smoker 175 may be operatively coupled to the hinged cover of the front compartment by a lifting mechanism, such as a hydraulic mechanism. In operation, opening the hinged cover may automatically raise the grill and smoker into a use position. The lifting mechanism may further include a locking feature to secure the components in the open position for safety. It is to be noted that one or more heating means can also be provided in the rear compartment. For example, FIG. 5 shows a propane grill 225 mounted within the rear compartment 115.

Additional items required for grilling or smoking may also be accommodated within the front compartment or elsewhere in the vehicle. For example, a gas cylinder may be mounted in the front or rear compartment, with a gas line routed to the front compartment to supply fuel. The grill may be configured as a charcoal grill, electric grill, or gas grill. In certain embodiments, other heating means, such as a stove, may also be incorporated into the front compartment. For example, the propane grill may be connected to a refillable tank secured within a ventilated compartment. The smoker may be insulated and includes a firebox with adjustable air vents, and it can be fueled with wood chips or pellets. The ample and isolated space provided within the front compartment facilitates integration of multiple cooking appliances while maintaining safe operation.

Both the grill 170 and smoker 175 provide a large surface area for cooking. When deployed in the use position, the height of the grill and smoker is ergonomically configured to provide comfort for the user during operation. For stowage, the user simply closes the front cover, whereby the grill and smoker are returned to a compact, stored position within the front compartment. A fire extinguisher may be mounted on a quick-release bracket adjacent to the cooking appliances. Fold-out aluminum or silicone flaps may extend behind or beneath the grills to shield the vehicle body from heat and grease.

The assembly further includes a kitchen station 180 positioned within the main compartment of the vehicle. The kitchen station is configured to support food preparation needs beyond heating. The kitchen station 180 comprises a large cabinet 230 configured to store cutlery, utensils, and food preparation items in an organized and easily accessible manner. A countertop is provided on the upper surface of the cabinet to serve as a workspace. In one embodiment, a cutting board 185 is positioned at the right front corner of the countertop for processing fruits and vegetables. An adjacent area behind the cutting board may be left open for temporary placement of items during preparation. On the left side of the countertop, a sink 190 is integrated into the composite surface. The sink may be connected to the water tank 135 via a suitable pump to provide water for washing and drinking. A grey-water tank may be installed in a cabinet 235 below the sink to collect wastewater. The sink may include one or more faucets, operable by a manual or battery-powered pump.

The cabinets of the kitchen station may be fabricated from lightweight, weather-resistant composite materials and mounted to the vehicle structure with vibration-isolated brackets. One or more drawers may include integrated cutlery trays and secure latches to prevent unintended opening during travel. The cutting boards may be detachable and configured to double as sink covers when the sink is not in use, thereby maximizing available workspace.

The kitchen station 180 may be mounted on either a stationary platform or a slidable platform 240. In embodiments utilizing a slidable platform, the kitchen station may be extended outward for use and retracted inward during travel. This configuration enhances accessibility by allowing the workspace to be pulled out to a convenient position for the user. The sliding movement may be supported on rails and may be actuated either manually or by a motorized mechanism. Another cabinet 195 is also shown in the drawings that can be used as additional storage space.

A minibar housing 200 may be mounted to one of the side doors 130 of the vehicle, the side door preferably is on rear of the main compartment. The minibar housing may include a tabletop surface and multiple storage compartments. In some embodiments, the minibar housing may be mounted on a slidable platform coupled to the side door, such that the housing is deployed outward when the side door is opened. The minibar housing may further comprise custom foam-lined compartments shaped to securely hold standard-sized liquor bottles and glassware. Each compartment may include an elastic strap or clamping mechanism to restrict movement of glassware during travel. A fold-down table surface may also be incorporated into the minibar door to facilitate preparation and serving of drinks. Additionally, in certain embodiments, liquor bottles may be stored in a roof rack 205 mounted to the vehicle.

The side doors of the vehicle may further include integrated storage compartments for holding various small articles and accessories. In certain embodiments, speakers 210 may be mounted within the side doors to provide a surround-sound experience. For example, marine-grade speakers may be incorporated into the door panels and driven by a dedicated amplifier. A pop-up or retractable television mount may also be provided to enhance entertainment functionality. All modules of the assembly may be secured using vibration-resistant mounts and lock-in-place rails or latches. The materials used in the construction of these modules may be heat-resistant, lightweight, and corrosion-proof to ensure durability during outdoor use.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A vehicle-integrated assembly for food preparation and entertainment, comprising:
a chassis;
a body mounted on the chassis, the body including a front compartment, a rear compartment, and a main compartment positioned between the front and rear compartments, wherein each of the front and rear compartments includes a hinged cover configured to be lifted upward, and the main compartment includes a plurality of side doors;
a kitchen station mounted within the main compartment, the kitchen station comprising a storage cabinet, a countertop workspace, and a sink fluidly connected to a water tank; and
a grill mounted within the front compartment and operably coupled to the hinged cover of the front compartment by a lifting mechanism, the lifting mechanism configured to raise the grill into a use position upon opening of the hinged cover.

2. The vehicle-integrated assembly of claim 1, further comprising a water tank mounted to a bottom portion of the chassis.

3. The vehicle-integrated assembly of claim 2, wherein the water tank extends across a substantial portion of the length and width of the chassis while maintaining a relatively low height.

4. The vehicle-integrated assembly of claim 1, further comprising a smoker mounted within the front compartment below the grill, the smoker operably coupled to the hinged cover of the front compartment such that the lifting mechanism is configured to raise both the grill and the smoker into the use position upon opening of the hinged cover.

5. The vehicle-integrated assembly of claim 1, further comprising a rear awning unit movable between a stowed position within the rear compartment and a deployed position adjacent to the vehicle, the rear awning unit comprising an awning coupled to the hinged cover of the rear compartment and a plurality of support poles.

6. The vehicle-integrated assembly of claim 1, wherein the kitchen station is mounted on a sliding platform configured to extend outward for use and retract inward during travel.

7. A towable vehicle for food preparation and entertainment, comprising:
a chassis having wheels and a hitch configured to couple to another vehicle;
a body mounted on the chassis, the body including a front compartment, a rear compartment, and a main compartment positioned between the front and rear compartments, wherein each of the front and rear compartments includes a hinged cover configured to be lifted upward, and the main compartment includes a plurality of side doors;
a kitchen station mounted within the main compartment, the kitchen station comprising a storage cabinet, a countertop workspace, and a sink fluidly connected to a water tank; and
a grill mounted within the front compartment and operably coupled to the hinged cover of the front compartment by a lifting mechanism, the lifting mechanism configured to raise the grill into a use position upon opening of the hinged cover.

8. The towable vehicle of claim 7, further comprising a water tank mounted to a bottom portion of the chassis.

9. The towable vehicle of claim 8, wherein the water tank extends across a substantial portion of the length and width of the chassis while maintaining a relatively low height.

10. The towable vehicle of claim 7, further comprising a smoker mounted within the front compartment below the grill, the smoker operably coupled to the hinged cover of the front compartment such that the lifting mechanism is configured to raise both the grill and the smoker into the use position upon opening of the hinged cover.

11. The towable vehicle of claim 7, further comprising a rear awning unit movable between a stowed position within the rear compartment and a deployed position adjacent to the vehicle, the rear awning unit comprising an awning coupled to the hinged cover of the rear compartment and a plurality of support poles.

12. The towable vehicle of claim 7, wherein the kitchen station is mounted on a sliding platform configured to extend outward for use and retract inward during travel.

13. A method of deploying a vehicle-integrated assembly for food preparation and entertainment, the method comprising:
providing a vehicle having a chassis, a body mounted on the chassis, a front compartment, a rear compartment, and a main compartment positioned between the front and rear compartments;
opening a hinged cover of the front compartment;
raising a grill mounted within the front compartment into a use position by actuating a lifting mechanism operably coupled between the grill and the hinged cover of the front compartment; and
preparing food on the grill in the use position.

14. The method of claim 13, further comprising supplying water to a sink of a kitchen station mounted within the main compartment, the sink being fluidly connected to a water tank mounted to the chassis.

15. The method of claim 13, further comprising raising a smoker mounted within the front compartment below the grill into the use position simultaneously with the grill by the lifting mechanism.

16. The method of claim 13, further comprising deploying a rear awning unit by opening a hinged cover of the rear compartment and extending a plurality of telescoping poles to support an awning coupled to the hinged cover of the rear compartment.

17. The method of claim 14, further comprising sliding the kitchen station mounted on a slidable platform outward from the main compartment to increase workspace accessibility.

18. The method of claim 13, further comprising deploying a minibar mounted on a side door of the vehicle by opening the side door, wherein the minibar includes foam-lined compartments for securely holding beverage bottles and glassware.
